(19) United States
(12) Patent Application Publication
(10) Pub. No.: US 2025/0304163 A1
(43) Pub. Date: Oct. 2, 2025

(54) CASCADED VERNIER ALGORITHM IN A METROLOGICALLY USED TWO-STAGE GEARING

(71) Applicant: HELLA GMBH & CO. KGAA, Lippstadt (DE)

(72) Inventor: Henning Irle, Lippstadt (DE)

(21) Appl. No.: 19/240,172

(22) Filed: Jun. 17, 2025

Related U.S. Application Data
(63) Continuation of application No. PCT/EP2023/079945, filed on Oct. 26, 2023.

(30) Foreign Application Priority Data
Dec. 19, 2022 (DE) 102022133934.3

(51) Int. Cl. B62D 15/02

(52) U.S. Cl. CPC B62D 15/0235

(57) ABSTRACT

The present invention relates to a steering actuator and to a method for a steer-by-wire system for determining a position of a lifting rod for steering purposes. The steering actuator includes a measuring gearing having a first axis of rotation, a second axis of rotation, and a third axis of rotation. The steering actuator also includes a first sensor for ascertaining a first position of the first axis of rotation, a second sensor for ascertaining a second position of the second axis of rotation, and a third sensor for ascertaining a third position of the third axis of rotation. The steering actuator further includes a control unit for receiving the first position, the second position and the third position. The control unit is configured to calculate a first, second, and third vernier function and to operate the steering actuator.

### CROSS-REFERENCE TO RELATED APPLICATIONS

The present application is a continuation of International Patent Application No. PCT/EP2023/079945, filed Oct. 26, 2023, which claims the benefit of DE 10-2022-133-934.3, filed Dec. 19, 2022, the disclosures of which are incorporated by reference.

### BACKGROUND OF THE INVENTION

The invention relates to a steering actuator, a method, a computer program product, a computer-readable data carrier, a control unit, and a vehicle.

Steering actuators are known which support the manual steering movement of a driver on a steering wheel. This is mainly used when there is a (physical) connection between the steering wheel and a steering rack (which is used to adjust the angle of the wheels) via a steering column. Steer-by-wire systems do not have this steering column. It is therefore not only necessary to support the steering, but a complete positioning control loop, via which a steering torque or a steering angle is specified by the steering wheel, and then a lifting rod (often no longer called a steering rack due to the lack of teeth) is positioned. In the lower area of the lifting rod, this can be achieved using a so-called road wheel actuator (RWA). The steer-by-wire system can therefore comprise a road-wheel actuator (RWA, in particular for operating a lifting rod) and a hand-wheel actuator (HWA, in particular comprising a decoupled steering wheel). In previous embodiments with a mechanical axle between the steering wheel and steering rack (e.g. EPS, Electric Power Steering), only torque support was provided. With a steer-by-wire system, a positioning task may have to be solved instead. In other words, the position of the lifting rod must be known and can be adjusted during operation. However, this requires precise knowledge of the position of the gear rack or the components connected to it. A drive device is required to move the lifting rod, wherein a motor and gearing combination with a strong transmission ratio can be used to apply the required force. The gearing often consists of several stages with different gearing topologies.

However, the devices and methods known in the prior art for determining the position have a number of disadvantages. For example, a gearing may be necessary to transfer the power of a drive device to the lifting rod. The resulting disadvantage is the ambiguity of the sensor information. While the information on the lifting rod is still clear, it has already become ambiguous at the first gearing stage. Today, it can be assumed that approx. 100 revolutions are required on the power pack or on a drive unit to move the steering of a typical car from the right steering stop to the left steering stop. To integrate a position sensor into the power pack, it is therefore necessary to resolve this ambiguity of approx. 100 revolutions in the power pack. As the position, particularly of rotationally symmetrical components, is repeated after a 360° rotation, it is not possible to differentiate or provide precise absolute information about the position of the lifting rod, particularly not unambiguously. In other words, an ambiguity can occur when determining the position (or angle measurement). Single-stage gearings, particularly with a high transmission ratio, in which, for example, a large gear wheel is used which does not complete a full revolution even when fully turned from left to right (of the wheels), do not have sufficient accuracy, and in particular measurement may be (metrologically) impossible. For example, a drive device can be designed to rotate from left to right dead point (i.e. full steering angle of the wheels) at around 100 revolutions. Accordingly, an accuracy of around 1/100 would be necessary. However, it is expensive and/or complicated to provide such accurate measuring devices. Furthermore, the installation space can be configured unfavorably in such gearing (e.g. due to the size of said gear wheel). Another disadvantage can be that a measurement is often carried out on the gear rack (or lifting rack). However, as this deforms, particularly under load (e.g. by 20 mm perpendicular to its extension), a (position) measurement may be falsified. Furthermore, this can lead to heavy mechanical loads on the sensors used. Accordingly, such sensors can be heavy, large and/or expensive. In addition, existing devices can cause comparatively high noise levels, for example because they have to be robust and/or structurally large. Furthermore, known devices often rely on (stored) reference values of the position, which can be particularly disadvantageous if the memory is deleted (e.g. when the battery is disconnected) and/or if the wheel angle is changed unnoticed (e.g. on a lifting platform during maintenance of a vehicle).

### SUMMARY OF THE INVENTION

The present invention is based on the object of providing a position measurement with greater accuracy. A reduction in installation space, weight, costs and/or (operating) noise can also be provided. In addition, it may be necessary to calculate back ambiguities over a larger area, particularly when using gearing, in order to be able to determine an exact position (e.g. of the lifting rod). In addition, it is an object of the present invention to determine the position without memory, reference and/or prior knowledge.

The above object is solved by a steering actuator with the features of independent claim 1, by a method with the features of independent claim 10, by a computer program product with the features of independent claim 12, by a computer-readable data carrier with the features of independent claim 13, by a control unit with the features of independent claim 14 and by a vehicle with the features of independent claim 15. Further features and details of the invention are apparent from the subclaims, the description and the drawings. Features and details described in connection with the steering actuator according to the invention naturally also apply in connection with the method according to the invention and/or in connection with the computer program product according to the invention and/or in connection with the computer-readable data carrier according to the invention and/or in connection with the control unit according to the invention and/or in connection with the vehicle according to the invention, and vice versa in each case, so that reference is or can always be made to the individual aspects of the invention with respect to the disclosure.

According to the invention, a steering actuator is provided for a steer-by-wire system for determining a position of a lift rod for steering, comprising a measuring gearing with a first axis of rotation, a second axis of rotation coupled to the first axis of rotation, and a third axis of rotation coupled to the first axis of rotation. The steering actuator further comprises a first sensor for ascertaining a first position of the first axis of rotation, a second sensor for ascertaining a second position of the second axis of rotation, and a third sensor for ascertaining a third position of the third axis of rotation. The steering actuator also comprises a control unit for receiving the first position, the second position and the third position. The control unit is configured to calculate a first vernier function based on the first position and the second position to obtain a first result, calculate a second vernier function based on the first position and the third position to obtain a second result, and calculate a third vernier function based on the first result and the second result to obtain a third result. The control unit is further configured to operate the steering actuator on the basis of the third result.

The steering actuator can be a so-called road-wheel actuator (RWA). The steering actuator can therefore be used to adjust the wheel angle (e.g. for steering a vehicle) by positioning a lifting rod, particularly in a steer-by-wire operation.

The steering actuator can be used to determine the position, in particular of the lifting rod. For this purpose, the position, for example an angular position, of the first, second and/or third axis of rotation can be determined. This can (without the solution according to the invention) lead to the ambiguities described above in particular, which are due to the periodicity or repetition of rotationally symmetrical components. The first, second and/or third axis of rotation can preferably be configured to be rotationally symmetrical. This allows easy production and/or uniform rotation.

The first, second and/or third axis of rotation can be configured to be substantially parallel. This can result in an optimized design of the installation space, so that, for example, an elongated and/or flat extension can be achieved. This can also lead to a simple and/or cost-effective production.

In particular, the measuring gearing can preferably be a two-stage gearing with three axes of rotation. This can advantageously lead to a lower (necessary) accuracy of the individual components without reducing the overall accuracy. For example, a two-stage gearing (as described above) may require a technically difficult to realize accuracy of 1/100, e.g. for a large gear wheel. A two-stage gearing can also have an accuracy of around 1/100, in particular due to the larger number of rotary axes and/or gear wheels, even if the accuracy of the individual components is only 1/10, for example. In particular in the present invention, a high accuracy can be achieved due to the interleaved vernier functions, particularly even if the components individually have a lower accuracy (e.g. compared to a two-stage solution).

Coupling can be achieved, in particular in each case, by means of interlocking. A first gear wheel can be arranged on the first axis of rotation to prevent rotation (see below). A second gear wheel can be arranged on the second axis of rotation to prevent rotation. A third gear wheel can be arranged on the third axis of rotation to prevent rotation. Neighboring gear wheels are preferably interlocked, which leads to a transmission of the rotary movements. The gear wheels can preferably be rotationally symmetrical. This allows easy production and/or uniform rotation.

In the context of the invention, it may be advantageous for the steering actuator to have a drive device, in particular an electric motor, for driving a lifting rod for steering, wherein preferably a rotary shaft of the drive device substantially coincides with the first axis of rotation, in particular is identical. It is also possible for the first axis of rotation to be coupled to the rotary shaft. The measuring gearing can be used as a purely metrological gearing. This can make it simpler and/or more cost-effective. The measuring gearing and/or the sensors can be integrated into the drive device. This can save installation space and/or reduce costs.

In this case, the steering actuator can have a control apparatus and a drive device (also known as a power pack). Preferably, the drive device is an electric motor, preferably brushless. This can minimize wear and/or maximize efficiency. For example, the electric motor can be operated at around 12V and 100 A. This can result in comparatively large forces. Preferably, the sensors or the measuring gearing are not or only partially exposed to these forces in order to be able to advantageously use less robust, smaller and/or less expensive materials. In addition, a more accurate measurement can be achieved if fewer forces are acting, for example because there is less deformation that could influence the position measurement. In addition to a brushless motor, the steering actuator (or the power pack) can include the necessary electronics for control, in particular the electronics of the power pack can have an output stage in the form of a so-called B6 bridge, a control logic of this output stage by an intelligent driver stage (called Gate Driver Unit (GDU), a microcontroller as a computing unit for control, communication and regulation, a position sensor for motor control and/or various interfaces for mostly bus systems such as the CAN bus for communication with the outside world. The rotary shaft can be aligned substantially parallel to a lifting rod of the vehicle. This can result in a particularly compact design.

Within the scope of the invention, it is conceivable that the first sensor, the second sensor and/or the third sensor are configured as multipole sensors, wherein these in particular provide at least two periods over a full revolution.

The first, second and/or third sensor can be included in the measuring gearing and/or integrated into it. These can be integrated with other electronics in the power pack. Interfaces can be simplified and/or connections no longer need to be protected against overvoltages, short circuits and/or swapping of cables, e.g. with external sensors. Shorter connections can also improve and/or avoid irradiation resistance and/or conducted coupling of electromagnetic interference.

The first, second and/or third sensor can enable the detection of the position, in particular angular position, of the first, second and/or third axis of rotation.

The first, second and/or third sensor can substantially provide a sawtooth signal, which is repeated periodically, in particular after one revolution) (360°.

A multipole sensor can have at least two wings, preferably identical and/or opposite one another. It may be particularly preferable to use three wings. In other words, such a 3-pitch can provide a periodicity of 120°. This can provide an influence on the revolutions required to achieve phase identity with another axis of rotation. With a larger number of poles or wings, the number of periods that are delivered over a full revolution (e.g. of an axis of rotation) can increase. Additionally or alternatively, smoother running can be achieved. Preferably, the sensors or the poles of the sensors can be integrated on and/or in a gear wheel. For example, the first sensor can be integrated, at least partially, on/or in the first gear wheel. For example, the second sensor can be integrated, at least partially, on/or in the second gear wheel. For example, the third sensor can be integrated, at least partially, on/or in the third gear wheel. It may be provided that the first, second and/or third sensor each have a first, second and/or third position detection, which preferably detects the poles located in the respective gear wheel. In this case, the position sensor can be arranged in a fixed position in order to enable position measurement, particularly in conjunction with the rotatable components of the sensor. Simplification and/or cost savings can be achieved through the structural proximity of the sensors and/or their design. This means that a more robust device can also be provided.

It may be particularly preferable if the second and third sensors are configured as multipole sensors.

It may be particularly preferable if the first, second and/or third sensors are designed as inductive sensors or comprise an inductive sensor.

It can be particularly preferred if the first, second and/or third sensors are configured as pure position sensors. It is possible that no torque is measured. This allows a simpler, more cost-effective and/or more robust design of the sensors.

Within the scope of the invention, it may be provided that the first sensor can be arranged (or is arranged) on or in the first axis of rotation, the second sensor can be arranged (or is arranged) on or in the second axis of rotation, and/or the third sensor can be arranged (or is arranged) on or in the third axis of rotation, wherein preferably the axes of rotation, sensors and/or the control unit are compactly integrated in the steering actuator. This allows the sensors to precisely monitor the (rotary) movements of the rotary axes.

This enables a compact and coherent steering actuator. This can advantageously save weight, costs and/or installation space. It can be replaced on a modular basis. It is possible that no further external electronics and/or sensors are required. This makes it possible to provide a particularly durable and/or well-protected system. Advantageously, this means that complicated and/or wear-prone measurement on a lifting rod can be avoided.

The device can be used as an alternative or in addition to a position measurement on a lifting rod (e.g. by a linear position sensor). Preferably, a measurement behind further gear stages of the drive device can be made possible.

It is also conceivable that the first axis of rotation has a first gear wheel, which can be arranged in particular in the center, wherein the second axis of rotation has a second gear wheel, which can be coupled to the first gear wheel in a toothed manner, and wherein the third axis of rotation has a third gear wheel, which can be coupled to the first gear wheel in a toothed manner.

In this case, the first and second axes of rotation, in particular the first and second gear wheels, can preferably not be in direct contact and/or coupled with each other, but preferably only with the first axis of rotation, in particular the first gear wheel.

Preferably, the first, second and/or third gear wheel are substantially in one plane. This allows the installation space to be minimized.

It is also conceivable that the measuring gearing has a spur gear. In this case, it can preferably be a two-stage gearing with three axes of rotation. In this case, a spur gearing can enable particularly compact and/or cost-effective production. In particular, the design can be advantageous due to the elongated extension, for example, this can enable particularly space-saving integration into an overall system. Other gearbox topologies such as belt gears, planetary gears or worm gears can also be provided.

Within the scope of the invention, it is optionally possible that the first gear wheel, the second gear wheel and/or the third gear wheel have substantially the same size and/or have substantially the same number of teeth. In this case, this can mean, for example, that the number of teeth is 30, 31, 33. This means that the number of teeth can be substantially the same and still differ.

In this case, it can be advantageous to use gear wheels of substantially the same size in order to enable the most uniform possible distribution and/or size of occupied installation space. This can also be advantageous in order to avoid generating excessive differences in rotational speed, which can minimize the forces and/or noise present.

Furthermore, it may be provided within the scope of the invention that the number of teeth of the first gear wheel, the second gear wheel and/or the third gear wheel differ, and/or the number of teeth of the first gear wheel, the second gear wheel and/or the third gear wheel corresponds to a prime number.

Particularly preferably, the number of teeth of the first, second and/or third gear wheel differ. This can be used to significantly extend the possible measuring range based on a vernier function. Due to the different number of teeth, it may be provided that during a full revolution (e.g. 360°) of one (e.g. first) gear wheel, a (directly) coupled (e.g. second) gearwheel does not complete a full revolution. Only after a few revolutions have been completed, e.g. a number resulting from the product of the number of teeth on one gear wheel and the number of teeth on the other, can the two gear wheels be in phase again. This allows the measuring position of the (associated) axis of rotation to be determined accurately, in particular unambiguously, over a large area. The fact that the third gear wheel also differs from the others in terms of its number of teeth provides another possibility (particularly analogous to the description above) to extend the measuring range. Advantageously, it can also be provided (as described above) to precisely determine the position of the axes of rotation, and in particular of the lifting rod (coupled to the first axis of rotation), at around 100 revolutions of a drive device. Preferably, this makes it possible to determine the position over the entire area from the outermost steering angle on the left of the steering to the outermost steering angle on the right of the steering.

Alternatively or additionally, it may be provided that the number of teeth of the first gear wheel, the second gear wheel and/or the third gear wheel corresponds to a prime number. This can advantageously lead to the avoidance and/or reduction of the resulting noises (in particular noise). A prime number can only be divisible by itself and by the value 1. A gear wheel that has a number of teeth that does not correspond to a prime number, e.g. 12 teeth, can have different harmonics during operation (rotation), e.g. the number 12 can be divided by the values 2, 3, 4 and 6 in addition to the values 1 and 12. This can therefore lead to different harmonics, which causes additional noise. This advantage can already be achieved if only one gear wheel has a number of teeth corresponding to a prime number. For example, a first gear wheel can have 31 teeth. The second gear wheel can have 30 teeth. The third gear wheel can have 33 teeth. The number of teeth would be substantially the same or not very different. In addition, the number of teeth of the first gear wheel is 31, which corresponds to a prime number. The advantage can be increased if two or even three gear wheels have a number of teeth corresponding to a prime number.

In relation to the present invention, it is conceivable that the first gear wheel, the second gear wheel and/or the third gear wheel are of lightweight construction, and preferably comprise a plastic material and/or that the first axis of rotation, the second axis of rotation and/or the third axis of rotation are of lightweight construction, and preferably comprise a plastic material.

This can be advantageous in each case in order to minimize and/or reduce the (total) weight. This can be particularly preferable in combination with optimized positioning of the measuring gearing. The forces on the measuring gearing can be reduced by arranging it close to the drive device, and in particular not directly on the lifting rod. This can therefore be exposed to lower forces and therefore be more robust. In addition, this allows the use of materials to advantageously save weight, in particular without jeopardizing robustness.

Preferably, a plastic material can be used. This can include polyamides, for example. It is also possible to use at least one of polyurethane (PUR), polyvinyl chloride (PVC) and/or acrylic butadiene styrene (ABS). The plastics can also and preferably be reinforced with glass fiber and/or carbon fiber.

Plastic can be lightweight, inexpensive, easy to manufacture and/or low-noise, particularly compared to metal. Particularly preferred can therefore be the combination of lightweight construction, in particular plastic, and the use of a number of teeth for the first, second and/or third gear wheel which corresponds to a prime number. This means that noise can be reduced particularly efficiently.

The above object is further achieved by a method according to the invention for operating, in particular controlling and/or regulating, a steering actuator of a steer-by-wire system. The method includes providing a steering actuator with a measuring gearing comprising a first axis of rotation, a second axis of rotation coupled thereto, and a third axis of rotation coupled to the first axis of rotation. The method further includes detecting a first position of the first axis of rotation with a first sensor, a second position of the second axis of rotation with a second sensor, and a third position of the third axis of rotation with a third sensor. The method includes receiving of the first position, the second position and the third position by a control unit. The method further includes calculating a first vernier function based on the first position and the second position to obtain a first result, calculating a second vernier function based on the first position and the third position to obtain a second result, and calculating a third vernier function based on the first result and the second result to obtain a third result. The method also includes operating the steering actuator based on the third result.

This results in the same advantages with regard to a method according to the invention as have already been described with regard to a steering actuator according to the invention.

The first vernier function can use the first position and the second position as input. According to the vernier principle, a first length scale (here in particular the first position or angular position) can be used and set in relation to a second length scale (here in particular the second position or angular position). The first result can have a (precise or more precise) determined position, e.g. first position. In other words, the position of the first axis of rotation and/or the lifting rod can be determined. The measuring range of the first axis of rotation and/or the first gear wheel is extended by using the vernier function with the second axis of rotation and/or the second gear wheel.

The same procedure can be used for a second vernier function, wherein the first and third positions are used as input.

The same method can then be used with a third vernier function. As this uses the first and second result as input, this can also be referred to as a cascaded or nested vernier function in order to resolve the ambiguities of the positions in an advantageous way. Cascading (further) extends the (clearly) determinable measuring range. This enables precise (in particular unambiguous) measurement of the first position and/or the position of a lifting rod, in particular over the entire range of movement of the lifting rod, for example over approximately 100 revolutions of a drive device. This can also be realized when (especially despite) being used with a gearing of the drive device. In other words, based (in particular exclusively based) on the first, second and/or third position, the position of the lifting rod can be determined unambiguously and/or accurately. This allows the position to be determined independently of reference values. The accuracy is greater or at least comparable (e.g. 1/100) with known methods. Due to the structural design, a simpler, more cost-effective and/or space-saving device can be provided. By using a control unit, precise coordination (e.g. with regard to hardware) with the device can be achieved. Furthermore, other computing units (of the vehicle) can be relieved. The vernier functions themselves cannot have an error. Accordingly, the (measurement) error can be predetermined by the tolerances of the rotary axes and/or gear wheels. It is therefore possible to use axes of rotation and/or gear wheels with a comparatively greater tolerance (e.g. 1/10 instead of 1/100) for the same (total) error. This can allow more cost-effective production. This can also enable the use of other materials, in particular plastic. Overall, the weight and/or the installation space can be optimized, in particular reduced.

Furthermore, it is conceivable that the third result comprises an actual position of a lifting rod for steering, wherein in particular an operation of the steering actuator based on the third result comprises an adaptation of the actual position of the lifting rod to a target position.

The target position can be specified. This can be done, for example, by a driver using a steering wheel, particularly in steer-by-wire mode. This can be transmitted to the control unit, which then sets the actual position of the lifting rod, in particular by moving the lifting rod with a drive device. The position (or positions) can be determined continuously. The angle of the wheels can be continuously adjusted by the driver.

The above object is further achieved by a computer program product according to the invention, comprising instructions which, when the computer program product is executed by a computer, cause the computer to implement the method according to any of the preceding claims.

This results in the same advantages with regard to a computer program product according to the invention as have already been described with regard to a steering actuator according to the invention and/or a method according to the invention.

The above object is further achieved by a computer-readable data carrier according to the invention, in which instructions are stored which, when executed by a computer, cause the computer to carry out the method according to any of the preceding claims.

This results in the same advantages with regard to a computer-readable data carrier according to the invention as have already been described with regard to a steering actuator according to the invention and/or a method according to the invention and/or a computer program product according to the invention.

The above object is further solved by a control unit according to the invention, having a computing unit and a memory unit in which instructions are stored which, when at least partially executed by the computing unit, carry out a method according to any of the preceding claims.

The control unit can be integrated into the steering actuator. This can enable a particularly advantageous and/or compact design, which can save costs in particular.

A control unit can be used to receive the first position, the second position and the third position, wherein the control unit is configured to calculate a first vernier function based on the first position and the second position to obtain a first result, a second vernier function based on the second position and the third position to obtain a second result, and a third vernier function based on the first result and the second result to obtain a third result. The control unit is further configured to operate the steering actuator on the basis of the third result.

Accordingly, the first, second and/or third result can be determined, in particular mathematically, by the control unit.

Furthermore, the control unit can be used to operate the steering actuator, in particular to control and/or regulate it. An external control signal, for example from another control apparatus and/or a steering wheel, can be received, in particular via a data connection. Based on this, the control unit can control the steering actuator via a data connection, for example to turn the drive device in one direction or the other. Accordingly, the lifting rod can be moved or positioned. In other words, the control unit can be used to control the drive device, causing it to apply torque and move the lifting rod. A (desired) position can therefore be approached.

The changed position can in turn be determined according to the invention, in particular in real time.

This results in the same advantages in relation to a control unit according to the invention as have already been described in relation to a steering actuator according to the invention and/or a method according to the invention and/or a computer program product according to the invention and/or a computer-readable data carrier according to the invention.

The above object is further achieved by a vehicle according to the invention having a steering actuator and/or a control unit according to any of the preceding claims.

The vehicle can have a steer-by-wire system comprising a road-wheel actuator (RWA, in particular for operating a lifting rod) and a hand-wheel actuator (HWA, in particular comprising a decoupled steering wheel). The vehicle preferably has a lifting rod that can be used to adjust the angle of the wheels. Accordingly, a movement, in particular a linear movement, e.g. in the right-left direction, of the lifting rod can lead to a change in the steering angle. This allows the vehicle to be controlled.

This results in the same advantages in relation to a vehicle according to the invention as have already been described in relation to a steering actuator according to the invention and/or a method according to the invention and/or a computer program product according to the invention and/or a computer-readable data carrier according to the invention and/or a control unit according to the invention.

### BRIEF DESCRIPTION OF THE DRAWINGS

Further advantages, features and details of the invention are apparent from the following description, in which several embodiments of the invention are described in detail with reference to the drawings. Here, the features mentioned in the claims and in the description can each be essential to the invention individually or in any combination. In the figures:

FIG. 1 is a vehicle,

FIG. 2 is a vehicle or its steering actuator for a steer-by-wire system,

FIG. 3 is a steering actuator for a steer-by-wire system,

FIG. 4 is a method for operating a steering actuator of a steer-by-wire system, and

FIG. 5 is an example curve of the vernier functions.

### DETAILED DESCRIPTION OF THE CURRENT EMBODIMENT

In the following figures, the same technical features, including those of different embodiment examples, are represented by identical reference numbers.

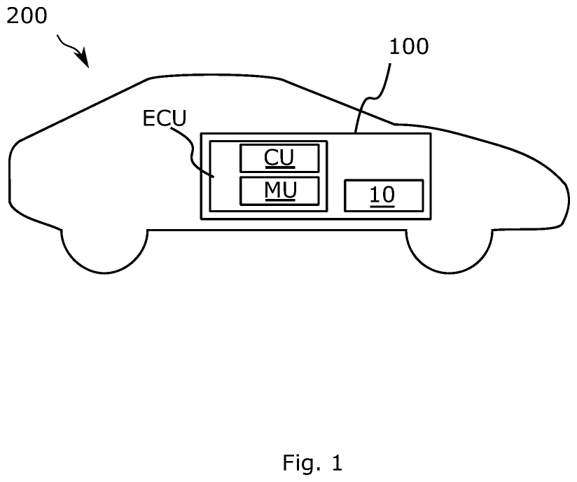

FIG. 1 shows a vehicle 200, for example a motor vehicle, which has a steering actuator 100. A steer-by-wire system can be realized. The steering actuator 100 can be used to adjust the steering angle of the wheels of the vehicle 200, for example on the front axis. The steering actuator 100 can have a control unit ECU and/or be connected to it for data communication. The control unit ECU can have a computing unit CU and a memory unit MU. To determine positions, in particular of the lifting rod and/or a first axis of rotation 11, the steering actuator 100 can have a measuring gearing 10. This can be used metrologically to enable ambiguities in determining the positions of rotationally symmetrical axes of rotation, for example behind a gearing that connects a lifting rod and a drive device 40 (e.g. electric motor) for moving the lifting rod.

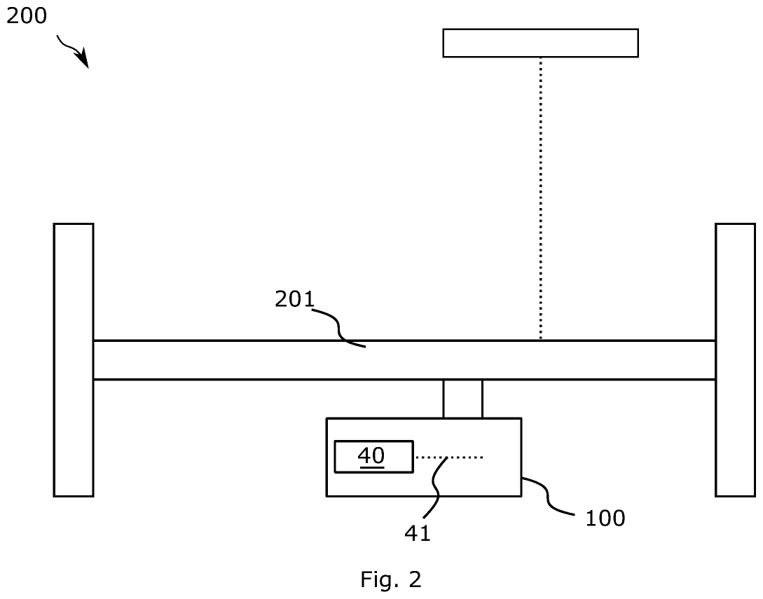

FIG. 2 shows an example or section of a vehicle 200. A lifting rod 201 is shown, at the ends of which wheels can be arranged, which can have a steering angle (adjustable by the lifting rod 201). A steering actuator 100 can be arranged on the lifting rod, which transmits a rotary movement of a drive device 40 (e.g. an electric motor) via a rotary shaft 41 to the lifting rod 201 in order to move it from left to right. A gearing can be connected in between. A measuring gearing 10 can also be included in the steering actuator 100 in order to resolve the ambiguity of positions. For example, the rotary shaft 41 may correspond to a first rotary axis 11. Furthermore, a (data) connection to a steering wheel (shown above) is indicated (dashed). This means that a steer-by-wire system can be realized.

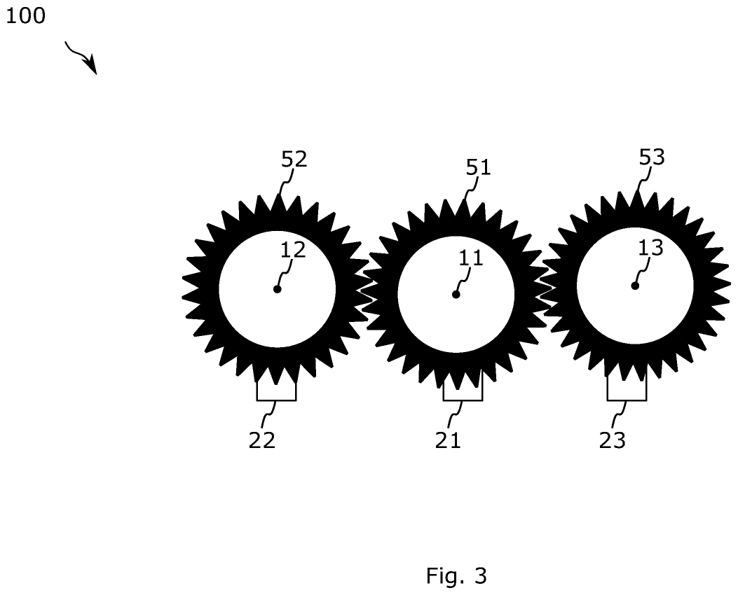

FIG. 3 shows an example of a first gear wheel 51, which is arranged in the center and has a number of 31 teeth. The first gear wheel 51 is centrally connected to a first axis of rotation 11 in a rotationally fixed manner. A first sensor 21 can determine the first position 31 of the first gear wheel 51 and/or the first axis of rotation 11.

FIG. 3 shows an example of a second gear wheel 52, which is arranged on the left and has a number of 30 teeth. The second gear wheel 52 is centrally connected to a second axis of rotation 12 in a rotationally fixed manner. A second sensor 22 may determine the second position 32 of the second gear wheel 52 and/or the second axis of rotation 12. The second gear wheel 52 is toothed with the first gear wheel 51 so that a rotary movement of the first gear wheel 51 is transmitted to the second gear wheel 52.

FIG. 3 shows an example of a third gear wheel 53, which is arranged on the right and has a number of 33 teeth. The third gear wheel 53 is centrally connected to a third axis of rotation 13 so that it cannot rotate. A third sensor 23 can determine the third position 33 of the third gear wheel 53 and/or the third axis of rotation 13. The third gear wheel 53 is toothed with the first gear wheel 51 so that a rotary movement of the first gear wheel 51 is transmitted to the third gear wheel 53.

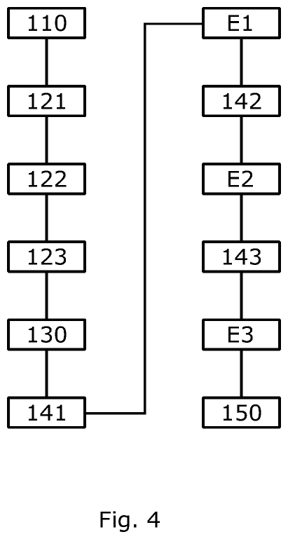

FIG. 4 shows an example of a method for operating, in particular controlling and/or regulating, a steering actuator 100 of a steer-by-wire system: providing 110 a steering actuator 100 with a measuring gearing 10 comprising a first axis of rotation 11, a second axis of rotation 12 coupled thereto, and a third axis of rotation 13 coupled to the first axis of rotation 11. The method further includes detecting 121 a first position 31 of the first axis of rotation 11 with a first sensor 21, detecting 122 a second position 32 of the second axis of rotation 12 with a second sensor 22, and detecting 123 a third position 33 of the third axis of rotation 13 with a third sensor 23. The method also includes receiving 130 of the first position 31, the second position 32 and the third position 33 by a control unit ECU. The method includes calculating 141 a first vernier function N1 based on the first position 31 and the second position 32 to obtain a first result E1, calculating 142 a second vernier function N2 based on the first position 31 and the third position 33 to obtain a second result E2, and calculating 143 a third vernier function N3 based on the first result E1 and the second result E2 to obtain a third result E3. The method further includes operating 150 the steering actuator 100 based on the third result E3.

By nesting the vernier functions, an ambiguity of the positions can be resolved. Advantageously, the third result E3 can be used to determine the exact position of a first axis of rotation 11 and/or a lifting rod 201. As part of a steer-by-wire system, an actual position of the lifting rod 201 can thus be provided. Operation can involve setting a (new) actual position based on a target position, which can be specified by a steering wheel, for example.

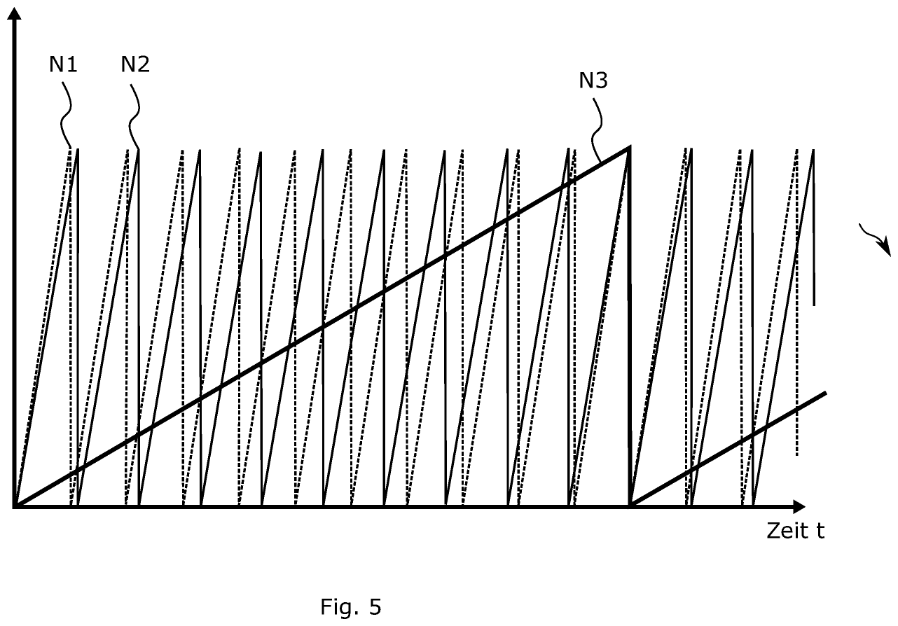

FIG. 5 shows an example of the curve (or the results E1, E2, E3) of the first vernier function N1, the second vernier function N2 and the third vernier function N3. For example, N1 and N2 are initially in phase (at the origin) and can therefore intersect at the origin. These then diverge over the time t (x-axis corresponds to time, y-axis to angle, e.g. up to) 360° until they intersect again at a later point in time after a few revolutions (e.g. 10 revolutions for N1 and 11 revolutions for N2) and, in particular, are in phase again. This can be the case, for example, if the first gear wheel 51 has a total of 31 teeth, the second gear wheel 52 has a total of 30 teeth and has a three-pole second sensor 22, and the third gear wheel 52 has a total of 33 teeth and a three-pole sensor 23. The first vernier function N1 can resolve an ambiguity over 10 revolutions. The second vernier function N2 can resolve an ambiguity over 11 revolutions. Due to the cascading through the vernier function N3, the entire measuring range can thus be clearly extended to 10*11=110 revolutions.

A comparable curve would also result for the first position 31 and the second position 32 over the time t (or analogously for the first position 31 and the third position 33). These are used as input for a first vernier function N1 to obtain the result E1. For example, the first position 31 and the second position 32 would initially be in phase (at the origin) and can therefore intersect at the origin. These then diverge over the time t until they intersect again at a later point in time after a few revolutions (e.g. 31 revolutions for the first position 31 or the first gear wheel 51 and 10 revolutions for the second position 32 or the second gear wheel 52) and, in particular, are again in phase. This can be the case, for example, if the first gear wheel 51 has a total of 31 teeth and the second gear wheel 52 has a total of 30 teeth and has a three-pole third sensor 22.

### LIST OF REFERENCE NUMBERS

10 Measuring gearing
11 First axis of rotation
12 Second axis of rotation
13 Third axis of rotation
21 First sensor
22 Second sensor
23 Third sensor
31 First position
32 Second position
33 Third position
40 Drive device
41 Rotary shaft
51 First gear wheel
52 Second gear wheel
53 Third gear wheel
100 Steering actuator
110 Providing a steering actuator
121 Detecting a first position
122 Detecting a second position
123 Detecting a third position
130 Receiving the first, second and third position
141 Calculating a first vernier function N1 to obtain E1
142 Calculating a second vernier function N2 to obtain E2
143 Calculating a third vernier function N3 to obtain E3
150 Operating the steering actuator based on E3
E1 First result
E2 Second result
E3 Third result
N1 First vernier function
N2 Second vernier function
N3 Third vernier function
200 Vehicle
201 Lifting rod
ECU Control unit
CU Computing unit
MU Memory unit

The above description is that of a current embodiment of the invention. Various alterations and changes can be made without departing from the spirit and broader aspects of the invention. This disclosure is presented for illustrative purposes and should not be interpreted as an exhaustive description of all embodiments of the invention or to limit the scope of the claims to the specific elements illustrated or described in connection with these embodiments. Any reference to elements in the singular, for example, using the articles “a,” “an,” “the,” or “said,” is not to be construed as limiting the element to the singular.

1. A steering actuator for a steer-by-wire system for determining a position of a lifting rod for steering, comprising:
a measuring gearing with a first axis of rotation, a second axis of rotation coupled to the first axis of rotation, and a third axis of rotation coupled to the first axis of rotation,
a first sensor for detecting a first position of the first axis of rotation,
a second sensor for detecting a second position of the second axis of rotation,
a third sensor for detecting a third position of the third axis of rotation,
a control unit for receiving the first position, the second position and the third position, wherein the control unit is configured to:
calculate a first vernier function based on the first position and the second position to obtain a first result,
calculate a second vernier function based on the first position and the third position to obtain a second result,
calculate a third vernier function based on the first result and the second result to obtain a third result, and
operate the steering actuator on the basis of the third result.

2. The steering actuator according to claim 1, wherein
the steering actuator has a drive device, optionally an electric motor, for driving the lifting rod for steering, wherein a rotary shaft of the drive device substantially coincides with the first axis of rotation, optionally is identical.

3. The steering actuator according to claim 1, wherein
the first sensor, the second sensor, and the third sensor are multipole sensors, wherein the first sensor, the second sensor, and the third sensor provide at least two periods over a full revolution.

4. The steering actuator according to claim 1, wherein
the first sensor is arranged on or in the first axis of rotation, the second sensor is arrangeable on or in the second axis of rotation, and the third sensor is arrangeable on or in the third axis of rotation, wherein the axes of rotation, sensors, and the control unit are optionally compactly integrated in the steering actuator.

5. The steering actuator according to claim 1, wherein
the first axis of rotation has a first gear wheel, which can be arranged in particular centrally, wherein the second axis of rotation has a second gear wheel, which can be coupled to the first gear wheel in a toothed manner, and wherein the third axis of rotation has a third gear wheel, which can be coupled to the first gear wheel in a toothed manner.

6. The steering actuator according to claim 1, wherein
the measuring gearing has a spur gearing.

7. The steering actuator according to claim 1, wherein
the first gear wheel, the second gear wheel and the third gear wheel are substantially the same size or have the same number of teeth.

8. The steering actuator according to claim 1, wherein
the number of teeth of the first gear wheel, the second gear wheel, and the third gear wheel differ, and
wherein the number of teeth of the first gear wheel, the second gear wheel and the third gear wheel is a prime number.

9. The steering actuator according to claim 1, wherein
the first gear wheel, the second gear wheel, and the third gear wheel comprise a plastic material, and
the first axis of rotation, the second axis of rotation, and the third axis of rotation comprise a plastic material.

10. A method of operating, controlling, or regulating a steering actuator of a steer-by-wire system, comprising:
providing a steering actuator with a measuring gearing comprising a first axis of rotation, a second axis of rotation coupled thereto, and a third axis of rotation coupled to the first axis of rotation,
detecting a first position of the first axis of rotation with a first sensor,
detecting a second position of the second axis of rotation with a second sensor,
detecting a third position of the third axis of rotation with a third sensor,
receiving of the first position, the second position, and the third position by a control unit,
calculating a first vernier function based on the first position and the second position to obtain a first result,
calculating a second vernier function based on the first position and the third position to obtain a second result,
calculating a third vernier function based on the first result and the second result to obtain a third result, and
operating the steering actuator based on the third result.

11. The method according to claim 10, wherein
the third result comprises an actual position of a lifting rod for steering, wherein operation of the steering actuator is based on the third result comprising adaptation of the actual position of the lifting rod to a target position.

12. A computer program product comprising instructions which, when executed by a computer, cause the computer to implement the method of claim 10.

13. A computer-readable medium comprising instructions which, when executed by a computer, cause the computer to implement the method of claim 10.

14. A control unit having a computing unit and a memory unit, the memory unit comprising instructions which, when executed by the computing unit, cause the computing unit to implement the method of claim 10.

15. A vehicle having a steering actuator according to claim 1.
